(19) United States
(12) Patent Application Publication
(10) Pub. No.: US 2026/0099180 A1
(43) Pub. Date: Apr. 9, 2026

(54) SEMICONDUCTOR DEVICE AND TEMPERATURE CONTROL METHOD

(71) Applicant: Renesas Electronics Corporation, Tokyo (JP)

(72) Inventor: Norio OZA, Tokyo (JP)

(21) Appl. No.: 19/331,190

(22) Filed: Sep. 17, 2025

(30) Foreign Application Priority Data
Oct. 7, 2024 (JP) 2024-176019

(51) Int. Cl. G06F 1/20; G06F 1/3206; G06F 1/3234; G06F 1/3287; G06F 1/3296

(52) U.S. Cl. CPC G06F 1/206; G06F 1/3206; G06F 1/3243; G06F 1/3287; G06F 1/3296

(57) ABSTRACT

To provide a semiconductor device capable of appropriately controlling temperature and its temperature control method. The semiconductor device according to the present disclosure includes a peripheral circuit, a CPU including a low breakdown voltage transistor for controlling the peripheral circuit, a temperature sensor including a high breakdown voltage transistor higher than the low breakdown voltage transistor, which outputs an analog signal indicating the measured temperature, an A/D converter including the high breakdown voltage transistor for converting the analog signal from the temperature sensor into a digital signal, and a control circuit including the high breakdown voltage transistor, which controls the peripheral circuit without passing through the CPU when the measured temperature indicated by the digital signal from the A/D converter exceeds a threshold temperature.

### CROSS-REFERENCE TO RELATED APPLICATIONS

The disclosure of Japanese Patent Application No. 2024-176019 filed on Oct. 7, 2024, including the specification, drawings and abstract is incorporated herein by reference in its entirety.

### BACKGROUND

The present disclosure relates to a semiconductor device and its temperature control method.

There are disclosed techniques listed below.

### [Patent Document 1] Japanese Unexamined Patent Application Publication No. 2001-144243

Patent Document 1 discloses a preventive safety device for a semiconductor integrated circuit. This device includes a temperature detection device, memory, an arithmetic unit, and an output device. If the temperature detected by the temperature detection device is outside the standard range, the arithmetic unit weighs the count value and stores it in memory. The output device issues an alarm when the count value exceeds a set value.

### SUMMARY

In Patent Document 1, the storage device stores a temperature determination program. The CPU (Central Processing Unit) executes the temperature determination program to detect the lifespan of the semiconductor integrated circuit. However, if the CPU itself overheats, there is a risk that the device may not operate normally.

Other issues and novel features will become apparent from the description of this specification and the accompanying drawings.

One aspect of the semiconductor device according to the present disclosure includes peripheral circuits, a CPU, a temperature sensor, and a high-voltage transistor, and comprises an A/D converter and a control circuit that controls the peripheral circuits without passing through the CPU when the measured temperature exceeds a threshold temperature.

The temperature control method for a semiconductor device according to one aspect of the present disclosure includes peripheral circuits, a CPU, a temperature sensor, a high-voltage transistor, an A/D converter, and a control circuit, and controls the peripheral circuits without passing through the CPU when the measured temperature exceeds a threshold temperature.

The present disclosure provides a semiconductor device capable of appropriately controlling temperature and its temperature control method.

### BRIEF DESCRIPTION OF THE DRAWINGS

FIG. 1 is a block diagram showing the configuration of a semiconductor device according to the first embodiment.

FIG. 2 is a graph showing changes in the measured temperature.

FIG. 3 is a graph showing changes in power supply voltage in control example 3.

FIG. 4 is a circuit diagram showing the configuration in control example 4.

FIG. 5 is a block diagram showing the configuration of a semiconductor device according to the second embodiment.

FIG. 6 is a graph for explaining multiple threshold temperatures.

FIG. 7 is a block diagram showing the configuration of a semiconductor device according to the third embodiment.

### DETAILED DESCRIPTION

The embodiments will be described below with reference to the drawings. Note that the drawings are simplified, and the technical scope of the embodiments should not be narrowly interpreted based on these drawings. The same elements are denoted by the same reference numerals, and redundant descriptions may be omitted.

### First Embodiment

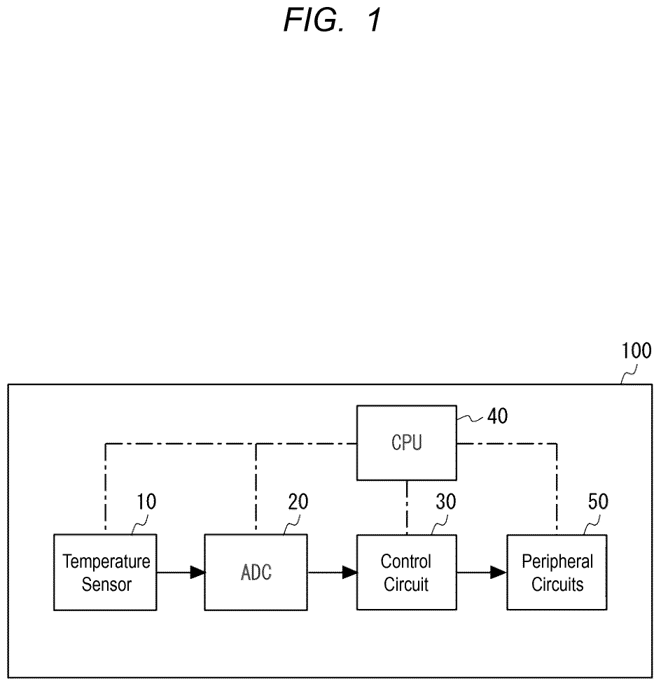

The configuration of the semiconductor device according to this embodiment will be described with reference to FIG. 1. FIG. 1 is a block diagram showing the configuration of the semiconductor device. The semiconductor device 100 includes a temperature sensor 10, an A/D converter 20, a control circuit 30, a CPU 40, and peripheral circuits 50. The semiconductor device 100 is, for example, a semiconductor chip such as a microcontroller.

The semiconductor device 100 is composed of two types of transistors with different voltage tolerances. Specifically, the semiconductor device 100 includes a high-voltage transistor with high voltage tolerance and a low-voltage transistor with low voltage tolerance. The high-voltage transistor has a higher voltage tolerance than the low-voltage transistor. For example, the operating voltage of the low-voltage transistor is 0.9 to 1.5V, and the operating voltage of the high-voltage transistor is 3.3 to 5.0V.

Additionally, the low-voltage transistor has a higher operating frequency than the high-voltage transistor. For example, the operating frequency of the low-voltage transistor is 100 MHz to 1000 MHz, and the operating frequency of the high-voltage transistor is about 50 MHz. The low-voltage transistor tends to have a significant increase in leakage current depending on the operating temperature. On the other hand, the increase in leakage current according to the operation is gradual. For example, the leakage current of the low-voltage transistor is about 1 A, and the leakage current of the high-voltage transistor is 10 mA. Therefore, the low-voltage transistor is more prone to thermal runaway than the high-voltage transistor. Specifically, when a voltage higher than the above operating voltage is applied to the transistor, leakage current occurs.

The CPU 40 is composed of low-voltage transistors. In other words, the CPU 40 has low-voltage transistors with a high operating frequency. The temperature sensor 10, A/D converter 20, and control circuit 30 have high-voltage transistors. The control circuit 30 has high-voltage transistors that are less prone to thermal runaway.

The temperature sensor 10 measures the internal temperature of the semiconductor device 100. The temperature sensor 10 is built into the semiconductor chip that becomes the semiconductor device 100. The temperature sensor 10 measures the internal temperature of the chip. The temperature sensor 10 outputs an analog signal indicating the measured temperature to the A/D converter 20. In other words, the analog signal output from the temperature sensor 10 has a voltage corresponding to the measured temperature.

The A/D converter 20 converts the analog signal to AD (Analog to Digital). Therefore, the signal output from the A/D converter 20 becomes a digital signal indicating the measured temperature.

The peripheral circuit 50 is an integrated circuit such as an IP (Intellectual Property) core with various functions. For example, the peripheral circuit 50 includes a power supply circuit or a memory circuit. The power supply circuit functions as an internal power supply for semiconductor device 100 and supplies the power supply voltage. The memory circuit includes SRAM (Static Random Access Memory), MRAM (Magnetoresistive Random Access Memory), flash memory, etc.

Of course, the peripheral circuit 50 is not limited to these circuits. For example, the peripheral circuit 50 may include a communication circuit, bus interface (IF) circuit, timer circuit, input/output circuit, sensor circuit, clock circuit, D/A converter, PLL circuit, etc. The peripheral circuit 50 may also be an image processing circuit, audio processing circuit, decode circuit, encode circuit, etc. The peripheral circuit 50 may have multiple IP cores.

The CPU 40 controls the temperature sensor 10, ADC 20, and peripheral circuit 50, etc. For example, the CPU 40 executes programs stored in memory, etc. For example, the CPU 40 performs predetermined arithmetic processing on data input from external or peripheral circuit 50. Then, the CPU 40 outputs the result of the arithmetic processing to the external or peripheral circuit 50.

The control circuit 30 is a circuit for performing temperature control. In other words, the control circuit 30 can appropriately control the temperature of the semiconductor device through its control. The digital signal from the A/D converter 20 is input to the control circuit 30. As described above, the digital signal from the A/D converter 20 is a signal indicating the measured temperature by the temperature sensor 10. The control circuit 30 compares the measured temperature with the threshold temperature. The control circuit 30 performs control to lower the temperature when the measured temperature exceeds the threshold temperature.

Specifically, when the measured temperature exceeds the threshold temperature, the control circuit 30 controls the peripheral circuit 50 without involving the CPU 40. By doing so, the temperature of the semiconductor device 100 can be appropriately controlled, thereby avoiding thermal runaway. When the measured temperature exceeds the threshold temperature, the semiconductor device 100 performs a safety operation to lower the temperature. Below, several control examples by the control circuit 30 will be described. In the following control examples 1 to 4, the control circuit 30 performs different controls. That is, in the following control examples 1 to 4, the semiconductor device 100 performs different safety operations.

### Control Example 1

In Control Example 1, the control circuit 30 controls the power circuit included in the peripheral circuit 50. The power circuit supplies the power voltage to the semiconductor device 100. When the measured temperature exceeds the threshold temperature, the control circuit 30 cuts off the supply of power voltage to some circuits or blocks.

For example, suppose the semiconductor device 100 is divided into multiple blocks (power domains). The power circuit can control the power on/off for each block. When the measured temperature exceeds the threshold temperature, the control circuit 30 outputs a control signal to the power circuit to control the power supply. Based on the control signal, the power circuit cuts off the power supply to one or more power domains.

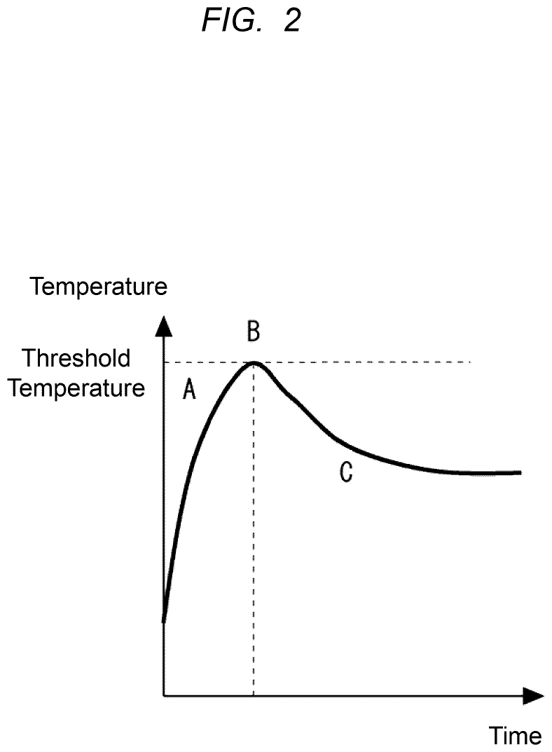

FIG. 2 is a graph for explaining the control by the control circuit 30. In FIG. 2, the horizontal axis represents time, and the vertical axis represents the measured temperature of the temperature sensor 10. Assume that the measured temperature rises over time (A in FIG. 2). The control circuit 30 compares the measured temperature with the threshold temperature. At the timing when the measured temperature reaches the threshold temperature (B in FIG. 2), the control circuit 30 stops the power supply. As a result, at least part of the operation of the peripheral circuit 50 stops, suppressing heat generation due to circuit operation. Therefore, the measured temperature gradually decreases (C in FIG. 2). By doing so, the internal temperature of the chip can be lowered, allowing the semiconductor device 100 to transition to a safe state. Thus, thermal runaway of the CPU 40 and the like can be avoided.

As described above, the CPU 40 is composed of low-voltage transistors. In the CPU 40, leakage current increases, and there is a risk of thermal runaway. On the other hand, the temperature sensor 10, A/D converter 20, and CPU 40 are composed of high-voltage transistors. Therefore, the temperature sensor 10, A/D converter 20, and control circuit 30 have low leakage current. When the measured temperature exceeds the threshold temperature, the control circuit 30 controls the peripheral circuit 50 without involving the CPU 40.

By doing so, the temperature of the semiconductor device 100 can be appropriately controlled, thereby avoiding thermal runaway. Specifically, based on the measured temperature, the control circuit 30 controls the power supply to the peripheral circuit 50 and the like. As a result, part of the operation of the peripheral circuit 50 stops. Heat generation due to the operation of the peripheral circuit 50 is suppressed. Therefore, the internal temperature of the chip can be lowered before it rises to a temperature at which the CPU 40 would experience thermal runaway. Furthermore, unexpected device damage can be avoided by preventing temperature rise.

Additionally, the power domains for which power supply is stopped may be changed stepwise according to the measured temperature. Multiple threshold temperatures can be prepared, and the power domains to be lowered can be set for each threshold temperature. For example, when the first threshold temperature is exceeded, the power supply to the first power domain is stopped. Next, when the second threshold temperature is exceeded, the power supply to the second power domain is stopped. In this way, the blocks for which power supply is cut off can be gradually expanded. As the measured temperature rises, power consumption is suppressed. Therefore, temperature rise can be effectively suppressed.

### Control Example 2

In Control Example 2, the control circuit 30 switches the operation mode of the semiconductor device 100. For example, semiconductor device 100 can operate in both a normal operation mode and a low power consumption mode. In the normal operation mode, the peripheral circuit 50 of the semiconductor device 100 operates normally. In the low power consumption mode, at least part of the circuits in the peripheral circuit 50 operate with lower power consumption than during normal operation. When the measured temperature exceeds the threshold temperature, the control circuit 30 transitions the peripheral circuit 50 to a low power consumption mode with lower power consumption than the normal operation mode. That is, the control circuit 30 transitions the semiconductor device 100 from the normal operation mode to the low power consumption mode.

For example, in the low power consumption mode, the function of some circuits stops. Alternatively, in the low power consumption mode, the operating speed of some circuits slows down. By doing so, at the timing when the measured temperature exceeds the threshold temperature (B in FIG. 2), heat generation can be suppressed. The measured temperature gradually decreases (C in FIG. 2). Since the internal temperature of the chip can be lowered, the semiconductor device 100 can transition to a safe state. Thus, thermal runaway of the CPU 40 and the like can be avoided. Furthermore, unexpected device damage can be avoided by preventing temperature rise.

Additionally, the mode may be changed stepwise according to the measured temperature. Multiple threshold temperatures can be prepared, and the mode to be set can be switched for each threshold temperature. As the measured temperature rises, power consumption is suppressed. Therefore, temperature rise can be effectively suppressed.

### Control Example 3

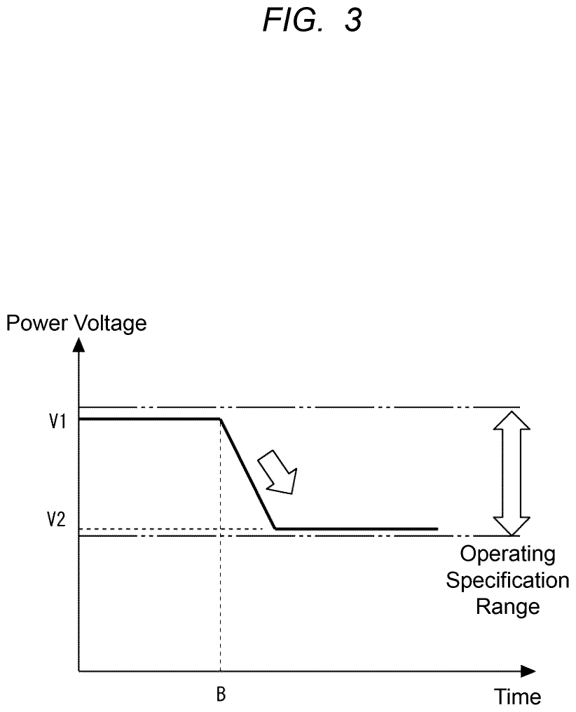

Control Example 3 will be explained using FIG. 3. FIG. 3 is a graph showing changes in power voltage. In Control Example 3, the control circuit 30 controls the power voltage supplied by the power circuit to be lowered. For example, as shown in FIG. 3, in the semiconductor device 100, an operating specification range is set for the power voltage within the chip. When the measured temperature is below the threshold temperature, the semiconductor device 100 operates at voltage V1 within the operating specification range. When the measured temperature exceeds the threshold temperature, the semiconductor device 100 operates at voltage V2 within the operating specification range.

Voltage V2 is lower than voltage V1. Voltage V2 is a voltage close to the lower limit of the operating specification range. That is, the control circuit 30 controls the power circuit to lower the power voltage supplied by the power circuit. By doing so, heat generation in the semiconductor device 100 can be suppressed. The control circuit 30 can appropriately control the temperature and avoid thermal runaway of the CPU 40. Furthermore, unexpected device damage can be avoided by preventing temperature rise.

Additionally, the power voltage may be lowered stepwise according to the measured temperature. For example, the control circuit 30 can store multiple threshold temperatures and set the power voltage to be lowered for each threshold temperature. By doing so, as the measured temperature rises, the power circuit lowers the power voltage. Therefore, temperature rise can be effectively suppressed.

### Control Example 4

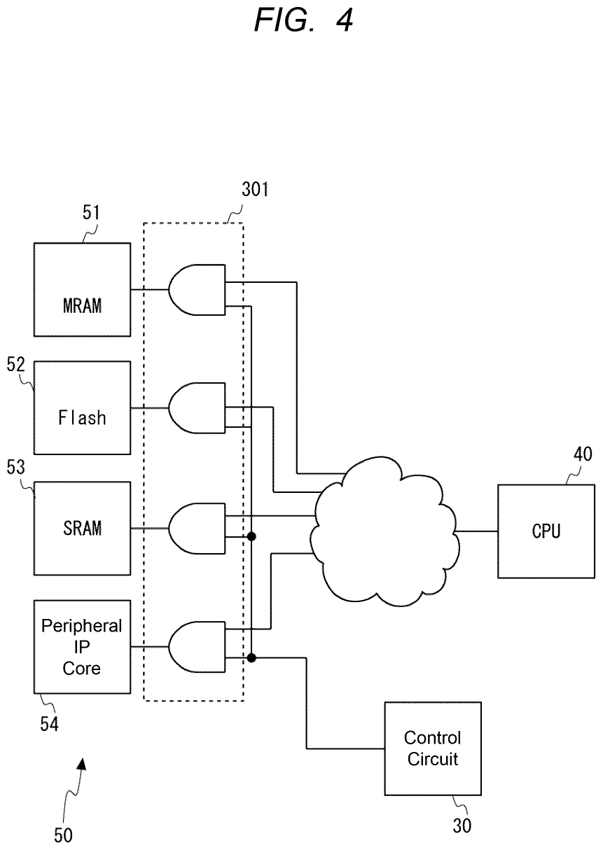

In Control Example 4, the control circuit 30 restricts access to the peripheral circuit 50 by the CPU 40. Control Example 4 will be explained using FIG. 4. FIG. 4 schematically shows an example of a circuit configuration. In FIG. 4, the peripheral circuit 50 includes MRAM 51, flash memory 52, SRAM 53, and peripheral IP core 54.

When the measured temperature is below the threshold temperature, the CPU 40 can access MRAM 51, flash memory 52, SRAM 53, and peripheral IP core 54. An access restriction circuit 301 is provided between the CPU 40 and the peripheral circuit 50. The access restriction circuit 301 restricts access to the peripheral circuit 50 by the CPU 40.

For example, when the access restriction circuit 301 imposes access restrictions, the CPU 40 cannot write data to MRAM 51, flash memory 52, or SRAM 53. Alternatively, when the access restriction circuit 301 imposes access restrictions, the CPU 40 cannot read data from MRAM 51, flash memory 52, or SRAM 53. That is, the access restriction circuit 301 restricts data writing and reading by the CPU 40.

The control circuit 30 controls the access restriction circuit 301 based on the measured temperature of the temperature sensor 10. When the measured temperature exceeds the threshold temperature, the control circuit 30 outputs a control signal to the access restriction circuit 301. As a result, control circuit 30 controls the access restriction circuit 301 so that access to peripheral circuit 50 by the CPU 40 is restricted. In FIG. 4, the access restriction circuit 301 includes a logic circuit such as an AND circuit. When the measured temperature exceeds the threshold temperature, the control circuit 30 outputs an L signal to the access restriction circuit 301. As a result, access to peripheral circuit 50 by the CPU 40 is restricted.

Additionally, when the measured temperature is below the threshold temperature, the control circuit 30 controls the access restriction circuit 301 so that access restrictions are not imposed. As a result, the CPU 40 can execute data writing and reading.

By doing so, heat generation due to data reading and writing can be suppressed. Furthermore, since data writing and reading are restricted at high temperatures, malfunction of the chip can be suppressed. Additionally, chip destruction can be prevented.

Furthermore, the access restriction by the access restriction circuit 301 may be applied to the peripheral IP core 54 other than MRAM 51, flash memory 52, and SRAM 53. When the access restriction circuit 301 imposes access restrictions, the CPU 40 cannot control the peripheral IP core 54. Since the operation of the peripheral IP core 54 stops, heat generation can be suppressed. Furthermore, malfunction at high temperatures can be suppressed, and chip destruction can be avoided. If there is an IP core for high-speed operations such as a DC-DC converter, it can prevent circuit malfunctions.

Additionally, the control circuit 30 may change access restrictions stepwise according to the measured temperature. The control circuit 30 stores multiple threshold temperatures and changes the IP core with access restrictions set for each threshold temperature. For example, if the first threshold temperature is exceeded, the control circuit 30 imposes access restrictions only on MRAM51. Next, if the second threshold temperature is exceeded, the control circuit 30 imposes access restrictions on both MRAM51 and flash memory 52. In this way, the range of IP cores subject to access restrictions can be gradually expanded.

### Second Embodiment

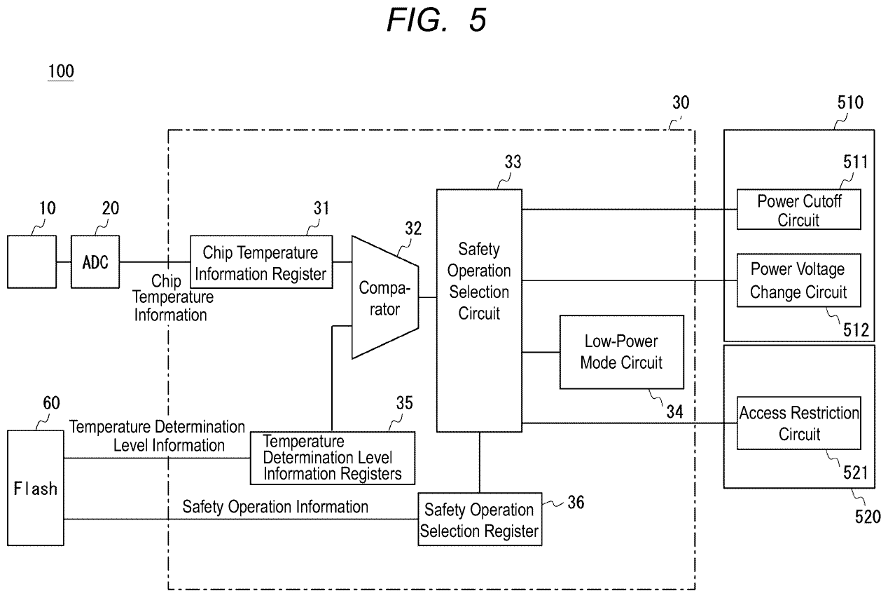

The semiconductor device according to the second embodiment will be described with reference to FIG. 5. FIG. 5 is a block diagram showing the circuit configuration of the semiconductor device 100. The semiconductor device 100 includes a temperature sensor 10, an A/D converter 20, a control circuit 30, and a flash memory 60. The semiconductor device 100 also includes a power circuit 510 and a memory 520. Note that the CPU 40 is omitted in FIG. 5.

Hereinafter, the common configurations and controls with the first embodiment will be appropriately omitted. For example, the temperature sensor 10, A/D converter 20, control circuit 30, and CPU 40 have the same functions as in the first embodiment. Additionally, the power circuit 510 and memory 520 correspond to the peripheral circuit 50 shown in the first embodiment.

The control circuit 30 includes a chip temperature information register 31, a comparator 32, a safety operation selection circuit 33, a low-power mode circuit 34, a temperature determination level information registers 35, and a safety operation selection register 36. The power circuit 510 includes a power cutoff circuit 511 and a power voltage change circuit 512. The power cutoff circuit 511 stops power supply to some circuits as shown in control example 1. The power voltage changes circuit 512 changes the power voltage as shown in control example 3.

When the temperature sensor 10 measures the chip temperature, it outputs an analog signal indicating the measured temperature to the A/D converter 20. The A/D converter 20 converts the analog signal to AD and outputs it to the chip temperature information registers 31. The signal output by the A/D converter 20 is referred to as chip temperature information. The chip temperature information is data indicating the measured temperature of the temperature sensor 10. The chip temperature information registers 31 stores the measured temperature.

The flash memory 60 stores temperature determination level information and safety operation information. The temperature determination level information is information related to threshold temperatures. In other words, the flash memory stores data indicating threshold temperatures.

The safety operation information indicates the safety operations to be executed when the temperature rises. For example, the operations of control examples 1 to 4 shown in the first embodiment are registered as safety operations. When the measured temperature exceeds the threshold, the control circuit 30 executes one of control examples 1 to 4 based on the data indicated by the safety operation information. The flash memory 60 stores data indicating the safety operations to be executed when the temperature rises as safety operation information.

The control circuit 30 reads the temperature determination level information and safety operation information stored in flash memory 60. For example, at the startup of the semiconductor device 100, the control circuit 30 reads the temperature determination level information and safety operation information from the flash memory 60. The temperature determination level information registers 35 stores the temperature determination level information. The temperature determination level information registers 35 may be updatable. The safety operation selection registers 36 stores the safety operation information. The value of the safety operation selection register 36 may be updatable.

Comparator 32 compares the chip temperature information with the temperature determination level information. In other words, the comparator 32 determines whether the measured temperature exceeds the threshold temperature. The comparator 32 outputs the comparison result to the safety operation selection circuit 33.

The safety operation selection circuit 33 refers to the value of the safety operation selection register 36 to select a safety operation. In other words, the safety operation selection circuit 33 selects a safety operation based on the safety operation information. The safety operation selection circuit 33 controls the execution of the selected safety operation when the measured temperature exceeds the threshold temperature.

As shown in control example 1, assume that stopping the power supply is a safety operation. In this case, the safety operation selection circuit 33 outputs a control signal to the power cutoff circuit 511. As a result, the power cutoff circuit 511 stops the power supply to some circuits from the power circuit 510. In this way, when the measured temperature exceeds the threshold temperature, the control circuit 30 stops the power supply without going through the CPU 40.

As shown in control example 2, assume that switching to a low-power mode is a safety operation. In this case, the safety operation selection circuit 33 outputs a control signal to the low-power mode circuit 34. As a result, the low-power mode circuit 34 switches the operation mode of the semiconductor device 100 from the normal operation mode to the low-power mode. In this way, when the measured temperature exceeds the threshold temperature, the control circuit 30 switches the mode without going through the CPU 40.

As shown in control example 3, assume that changing the power voltage is a safety operation. In this case, the safety operation selection circuit 33 outputs a control signal to the power voltage change circuit 512. As a result, the power voltage change circuit 512 lowers the power voltage of the semiconductor device 100. In this way, when the measured temperature exceeds the threshold temperature, the control circuit 30 lowers the power voltage without going through the CPU 40.

As shown in control example 4, assume that access restriction to peripheral circuits is a safety operation. In this case, the safety operation selection circuit 33 outputs a control signal to the access restriction circuit 521. As a result, the access restriction circuit 521 restricts access from the CPU 40 to the memory 520 and the like. In this way, when the measured temperature exceeds the threshold temperature, the control circuit 30 imposes access restrictions without going through the CPU 40. Note that the memory 520 may be SRAM, MRAM, flash memory, etc.

The flash memory 60 stores temperature determination level information and safety operation information. Therefore, the threshold temperature and safety operations can be variable. For example, by updating the settings of the flash memory 60, the user can update the threshold temperature and safety operations through control circuit 30. The semiconductor device 100 can execute appropriate safety operations. For example, the user can change the safety operations according to the usage environment of the semiconductor device 100. In other words, by changing the threshold temperature and safety operations, the user can more effectively suppress device damage due to temperature rise.

Specifically, the user can change the temperature determination level information indicating the threshold temperature by rewriting the value of the flash memory 60. The user can set an appropriate threshold temperature for the semiconductor device 100. Alternatively, the user can change the safety operations by rewriting the value of the flash memory 60. Therefore, the user can set effective safety operations for the semiconductor device 100. Of course, non-volatile memory other than the flash memory 60 may store the settings. The user only needs to rewrite the memory settings.

By doing so, the user can set the threshold temperature and safety operations, allowing for appropriate control of the temperature of the semiconductor device 100. Additionally, the value of the flash memory 60 is transferred to the register at the startup of the semiconductor device 100. Therefore, by simply rewriting the value of the flash memory 60 according to the usage environment, the user can update the threshold temperature and safety operations. Note that the executed safety operations are not limited to one and maybe two or more. For example, lowering the power voltage and restricting access to peripheral circuits may be performed simultaneously. The safety operation selection registers 36 stores multiple safety operation information.

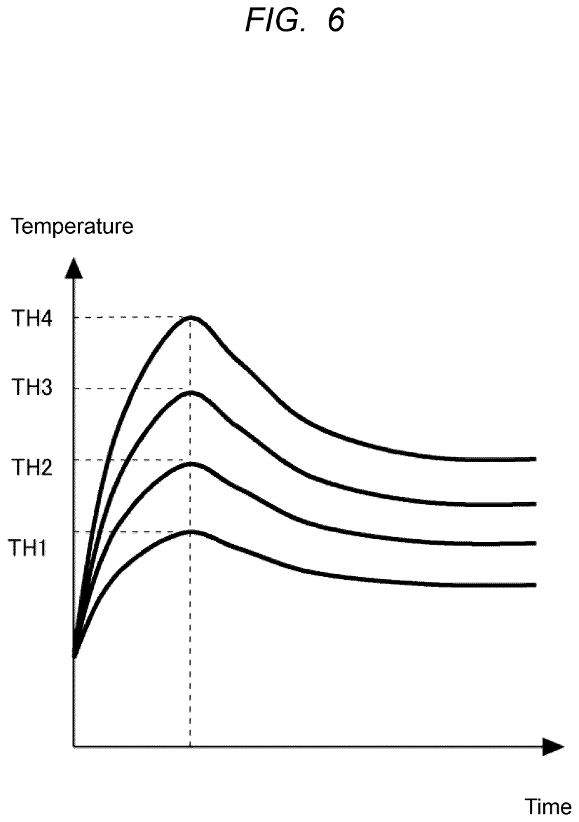

Multiple threshold temperatures may be set to perform safety operations stepwise. As shown in FIG. 6, the temperature determination level information registers 35 stores four threshold temperatures TH1, TH2, TH3, and TH4. The threshold temperature TH1 is the lowest temperature, and the threshold temperature TH4 is the highest temperature. The threshold temperature TH2 is a temperature between the threshold temperature TH3 and the threshold temperature TH1. Additionally, the flash memory 60 stores four threshold temperatures TH1 to TH4 as temperature determination level information. The safety operation selection register 36 stores four safety operation information. Safety operation information is associated with each of the threshold temperatures TH1 to TH4.

For example, if the measured temperature exceeds the threshold temperature TH1, the control circuit 30 imposes access restrictions on the peripheral circuit 50. If the measured temperature exceeds the threshold temperature TH2, the control circuit 30 lowers the power voltage. If the measured temperature exceeds the threshold temperature TH3, the control circuit 30 transitions to a low-power mode. If the measured temperature exceeds the threshold temperature TH4, the control circuit 30 cuts off the power supply. The higher the threshold temperature, the more effective the safety operation is set.

The flash memory 60 stores multiple threshold temperatures and multiple safety operations in association. This allows changing the safety operations according to the threshold temperature. This allows effectively lowering the temperature of the semiconductor device 100. For example, if the temperature does not decrease with some safety operations, more effective safety operations are executed. Of course, multiple safety operations may be set for one threshold temperature.

### Third Embodiment

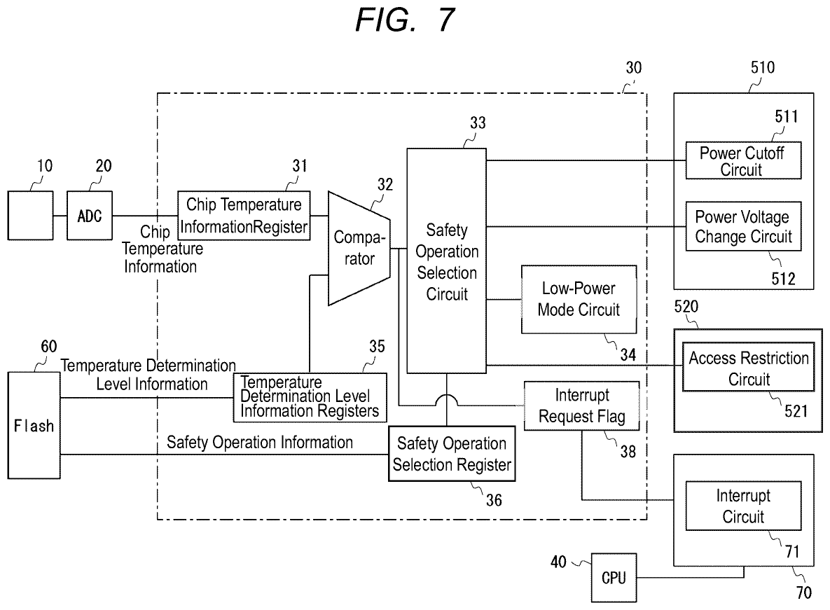

The semiconductor device 100 according to the present embodiment will be described with reference to FIG. 7. FIG. 7 is a block diagram showing the circuit configuration of the semiconductor device 100. In this embodiment, an interrupt control circuit 70 is added to the configuration of the second embodiment. The interrupt control circuit 70 includes an interrupt circuit 71. Additionally, the control circuit 30 has an interrupt request flag 38. The basic configuration and operation of the semiconductor device 100 are similar to those of the first and second embodiments, so the explanation is omitted as appropriate.

The comparator 32 sets the interrupt request flag 38 when the measured temperature is higher than the threshold temperature. When the interrupt request flag 38 is set, it notifies the interrupt control circuit 70 that the measured temperature has exceeded the threshold temperature. The interrupt control circuit 70 includes an interrupt circuit 71. When the interrupt request flag 38 is set, the interrupt circuit 71 issues an interrupt request to the CPU 40. By doing so, the control circuit 30 interrupts the processing of the CPU 40 to perform safe operation. Therefore, the control circuit 30 can promptly execute safe operation. For example, before the CPU 40 performs data writing or reading processing to the memory 520, it executes access restrictions.

This allows for the avoidance of unexpected device damage and the suppression of chip malfunction.

Although the invention made by the present inventor has been specifically described based on the embodiment, the present invention is not limited to the above-described embodiment, and it is needless to say that various modifications can be made without departing from the gist thereof.

What is claimed is:

1. A semiconductor device comprising:
a peripheral circuit;
a CPU (Central Processing Unit) including a low breakdown voltage transistor for controlling the peripheral circuit;
a temperature sensor including a high breakdown voltage transistor higher than the low breakdown voltage transistor, which outputs an analog signal indicating the measured temperature;
an A/D converter including the high breakdown voltage transistor for converting the analog signal from the temperature sensor into a digital signal; and
a control circuit including the high breakdown voltage transistor, which controls the peripheral circuit without passing through the CPU when the measured temperature indicated by the digital signal from the A/D converter exceeds a threshold temperature.

2. The semiconductor device according to claim 1, wherein the peripheral circuit includes a power supply circuit, and the control circuit cuts off the power supply of the power supply circuit when the measured temperature exceeds the threshold temperature.

3. The semiconductor device, according to claim 1, wherein the control circuit shifts the peripheral circuit to a low power consumption mode with lower power consumption than the normal operation mode when the measured temperature exceeds the threshold temperature.

4. The semiconductor device according to claim 1, wherein the peripheral circuit includes a power supply circuit, and the control circuit controls to lower the power supply voltage supplied by the power supply circuit when the measured temperature exceeds the threshold temperature.

5. The semiconductor device according to claim 1, wherein the control circuit restricts access to the peripheral circuit when the measured temperature exceeds the threshold temperature.

6. The semiconductor device according to claim 1, wherein the control circuit includes a register for storing setting values and changes the threshold temperature by updating the setting values of the register.

7. The semiconductor device according to claim 6, further comprising non-volatile memory for storing the setting values, and transferring the values stored in the non-volatile memory to the register at the startup of the semiconductor device.

8. The semiconductor device according to claim 6, wherein the register stores multiple setting values, and the control circuit performs different controls according to the setting values.

9. A temperature control method for a semiconductor device comprising:
a peripheral circuit;
a CPU (Central Processing Unit) for controlling the peripheral circuit;
a temperature sensor outputting an analog signal indicating the measured temperature;
an A/D converter for converting the analog signal from the temperature sensor into a digital signal; and
a control circuit including a low breakdown voltage transistor lower than the high breakdown voltage transistor included in the temperature sensor, the A/D converter, and the CPU,
wherein the control circuit compares the measured temperature indicated by the digital signal from the A/D converter with a threshold temperature, and controls the peripheral circuit without passing through the CPU when the measured temperature exceeds the threshold temperature.

10. The temperature control method for a semiconductor device according to claim 9, wherein the peripheral circuit includes a power supply circuit, and the control circuit cuts off the power supply of the power supply circuit when the measured temperature exceeds the threshold temperature.

11. The temperature control method for a semiconductor device according to claim 9, wherein the control circuit shifts the peripheral circuit to a low power consumption mode with lower power consumption than the normal operation mode when the measured temperature exceeds the threshold temperature.

12. The temperature control method for a semiconductor device according to claim 9, wherein the peripheral circuit includes a power supply circuit, and the control circuit controls to lower the power supply voltage supplied by the power supply circuit when the measured temperature exceeds the threshold temperature.

13. The temperature control method for a semiconductor device according to claim 9, wherein the control circuit restricts access to the peripheral circuit when the measured temperature exceeds the threshold temperature.

14. The temperature control method for a semiconductor device according to claim 9, wherein the control circuit includes a register for storing setting values and changes the threshold temperature by updating the setting values of the register.

15. The temperature control method for a semiconductor device according to claim 14, further comprising non-volatile memory for storing the setting values, and transfers the values stored in the non-volatile memory to the register at the startup of the semiconductor device.

16. The temperature control method for a semiconductor device according to claim 15, wherein the register stores multiple setting values, and the control circuit performs different controls according to the setting values.
